(19) United States
(12) Patent Application Publication
(10) Pub. No.: US 2022/0036791 A1
(43) Pub. Date: Feb. 3, 2022

(54) DRIVING METHOD OF DISPLAY PANEL AND DISPLAY DEVICE

(71) Applicant: HKC CORPORATION LIMITED, Shenzhen (CN)

(72) Inventors: Zeyao LI, Shenzhen (CN); Haijiang YUAN, Shenzhen (CN)

(21) Appl. No.: 17/181,105

(22) Filed: Feb. 22, 2021

(30) Foreign Application Priority Data
Jul. 28, 2020 (CN) 202010741147.1

(51) Int. Cl. G09G 3/20; G09G 3/3266; G09G 3/3275

(52) U.S. Cl. CPC G09G 3/2003; G09G 2300/0452; G09G 3/3275; G09G 3/3266

(57) ABSTRACT

A driving method of a display panel and a display device are disclosed. The driving method includes: obtaining a first preset scanning driving signal and a second preset scanning driving signal with different driving periods; dividing a driving period for driving two adjacent rows of sub-pixels into a first driving period and a second driving period; dividing two adjacent rows of sub-pixels into a first group of sub-pixels and a second group of sub-pixels; driving the first group of sub-pixels with the first preset scanning driving signal at the first driving period; acquiring a period switching signal and switching the first driving period to the second driving period; and driving the second group of sub-pixels with the second preset scanning driving signal.

### CROSS REFERENCE TO RELATED APPLICATIONS

The present disclosure claims the priority to Chinese patent application No. 202010741147.1, which is entitled “DRIVING METHOD OF DISPLAY PANEL AND DISPLAY DEVICE” and filed on Jul. 28, 2020, the entirety content of which is incorporated herein by reference.

### TECHNICAL FIELD

The disclosure relates to the technical field of liquid crystal displays, in particular to a driving method of display panel and a display device.

### BACKGROUND

The statement herein only provides background information related to the present disclosure and does not necessarily constitute the prior art.

Organic Light Emitting Diode (OLED) is usually driven by a DC mode. The transmission directions of holes and electrons are fixed, and are respectively inject to a light emit layer from positive and negative electrodes. Excitons are formed in the light emitting layer to emit light. However, the excess holes or electrons that do not participate in the recombination, may be accumulated in the hole transport layer/light emitting layer interface, or in the light emitting layer/electron transport layer interface, or cross the barrier and flow into the electrode. With the extension of working time, the organic light emitting diode will accumulate many unrecombined holes or electrons at an internal interface of the light emitting layer, thus forming a built-in electric field inside, causing the threshold voltage to be continuously increased, and the light emitting brightness to be continuously decreased, thus shortening the service life of the organic light emitting diode.

### SUMMARY

The main object of the present disclosure is to provide a driving method and display of a display panel. The disclosure aims to solve the technical problems of short service life, uneven brightness and low energy utilization rate of light emitting diodes.

To achieve the above objective, the present disclosure provides a driving method of a display panel. The display panel includes a display array including sub-pixels arranged in an array. The driving method includes:

acquiring a first preset scanning driving signal and a second preset scanning driving signal, the first preset scanning driving signal and the second preset scanning driving signal being in different driving periods;

dividing a driving period for driving two adjacent rows of sub-pixels into a first driving period and a second driving period, and dividing the two adjacent rows of sub-pixels into a first group of sub-pixels and a second group of sub-pixels;

at the first driving period, driving the first group of sub-pixels by adopting the first preset scanning driving signal;

acquiring a period switching signal, and switching the first driving period to the second driving period according to the period switching signal; and

driving the second group of sub-pixels by adopting the second preset scanning driving signal.

In one embodiment, dividing the two adjacent rows of sub-pixels into a first group of sub-pixels and a second group of sub-pixels includes:

dividing the two adjacent rows of sub-pixels into the first group of sub-pixels and the second group of sub-pixels in an odd-even interpolation manner.

In one embodiment, dividing the two adjacent rows of sub-pixels into the first group of sub-pixels and the second group of sub-pixels in an odd-even interpolation manner comprises:

setting odd-numbered columns sub-pixels in a first row and even-numbered column sub-pixels in a second row of the two adjacent rows of sub-pixels as the first group of sub-pixels; and

setting even-numbered column sub-pixels in the first row and odd-numbered column sub-pixels in the second row of the two adjacent rows of sub-pixels as the second group of sub-pixels.

In one embodiment, the period switching signal is a frame signal, a time signal, or a power on/off signal.

In one embodiment, after driving the second group of sub-pixels by adopting the second preset scanning driving signal, the method further comprises:

acquiring a preset data driving signal, and driving the two adjacent rows of sub-pixels by adopting the preset data driving signal.

In one embodiment, before acquiring a first preset scanning driving signal and a second preset scanning driving signal, the method further comprises:

setting the two adjacent rows of sub-pixels as red sub-pixels, green sub-pixels and blue sub-pixels in sequence.

Besides, to realize the purpose above, the present disclosure further provides a display panel including a display array including sub-pixels arranged in an array; the driving method of display panel includes:

dividing scanning lines of the display array into two groups including a first group of scanning lines and a second group of scanning lines, connecting odd-numbered column sub-pixels in a first row and even-numbered column sub-pixels in a second row of two adjacent rows of sub-pixels with the first group of scanning lines, and connecting even-numbered column sub-pixels in the first row and odd-numbered column sub-pixels in the second row with the second group of scanning lines;

acquiring a first preset scanning driving signal output by the first group of scanning lines and a second preset scanning driving signal output by the second group of scanning lines, the first preset scanning driving signal and the second preset scanning driving signal adopting different driving times;

dividing a driving period for driving the two adjacent rows of sub-pixels into a first driving period and a second driving period;

acquiring a current frame signal, a time signal or a power on/off signal, and driving the odd-numbered column sub-pixels in the first row and the even-numbered column sub-pixels in the second row of the two adjacent rows of sub-pixels by adopting the first preset scanning driving signal during the first driving period;

acquiring a period switching signal, and switching the first driving period to the second driving period according to the period switching signal; and

driving the even-numbered column sub-pixels in the first row and the odd-numbered column sub-pixels in the second row by adopting the second preset scanning driving signal.

Besides, to realize the purpose above, the present disclosure further provides a display device, wherein the display device includes: a display panel, a memory, a processor, and a driver of the display panel stored on the memory and operable on the processor, the display panel includes a display array including pixel cells arranged in an array, and the driver of the display panel is to implement the driving method above when being executed by the processor.

In one embodiment, the display panel includes a scanning line, a data line, a light emitting diode, a first thin film transistor, a second thin film transistor, a first power supply, a second power supply and a storage capacitor, the scanning line includes a first scanning line and a second scanning line, the first scanning line is for outputting a first preset scanning driving signal, and the second scanning line is for outputting a second preset scanning driving signal.

The scanning line is connected to a grid of the first thin film transistor, a source of the first thin film transistor is connected to the data line, a drain of the first thin film transistor is connected to a grid of the second thin film transistor, one terminal of the storage capacitor is connected to the drain of the first thin film transistor, the other terminal of the storage capacitor is connected with a source of the second thin film transistor, the source of the second thin film transistor is connected with the first power supply, a drain of the second thin film transistor is connected with a positive electrode of the light emitting diode, and a negative electrode of the light emitting diode is connected with the second power supply.

In one embodiment, the light emitting diode is an organic light emitting diode.

In the present disclosure, a first preset scanning driving signal and a second preset scanning driving signal are acquired, the first preset scanning driving signal and the second preset scanning driving signal adopt different driving times, a driving period for driving two adjacent rows of sub-pixels into a first driving period and a second driving period is divided, and the two adjacent rows of sub-pixels are divided into a first group of sub-pixels and a second group of sub-pixels. At the first driving period, the first group of sub-pixels is driven by adopting the first preset scanning driving signal. When a period switching signal is acquired, it is switched from the first driving period to the second driving period according to the period switching signal, and the second preset scanning driving signal is adopted to drive the second group of sub-pixels, so as to alternately drive the current sub-pixels, reduce the driving frequency of the sub-pixels, and achieve the purpose of improving the service life of the light emitting diode.

### BRIEF DESCRIPTION OF THE DRAWINGS

FIG. 1 is a schematic diagram of a structure of a display device of a hardware operating environment involved in embodiments of the present disclosure.

FIG. 2 is a schematic structural diagram of a first embodiment of an exemplary display array.

FIG. 3 is a schematic structural diagram of a first embodiment of a display array of the present disclosure.

FIG. 4 is a flow diagram of a first embodiment of a driving method of display panel of the present disclosure.

FIG. 5 is a schematic diagram of a display effect of a first driving period of the driving method of display panel of the present disclosure.

FIG. 6 is a schematic diagram of a display effect of a second driving period of the driving method of display panel of the present disclosure.

FIG. 7 is a flow diagram of a second embodiment of the driving method of display panel of the present disclosure.

FIG. 8 is a structural diagram of the display device of the present disclosure.

FIG. 9 is the structural diagram of a first embodiment of a display panel in the display device of the present disclosure.

The realization of purposes, functional features and advantages of the present disclosure will be further explained in connection with embodiments and with reference to the accompanying drawings.

### DETAILED DESCRIPTION OF THE EMBODIMENTS

It should be understood that the specific embodiments described herein are intended to explain the disclosure only and are not intended to limit the disclosure.

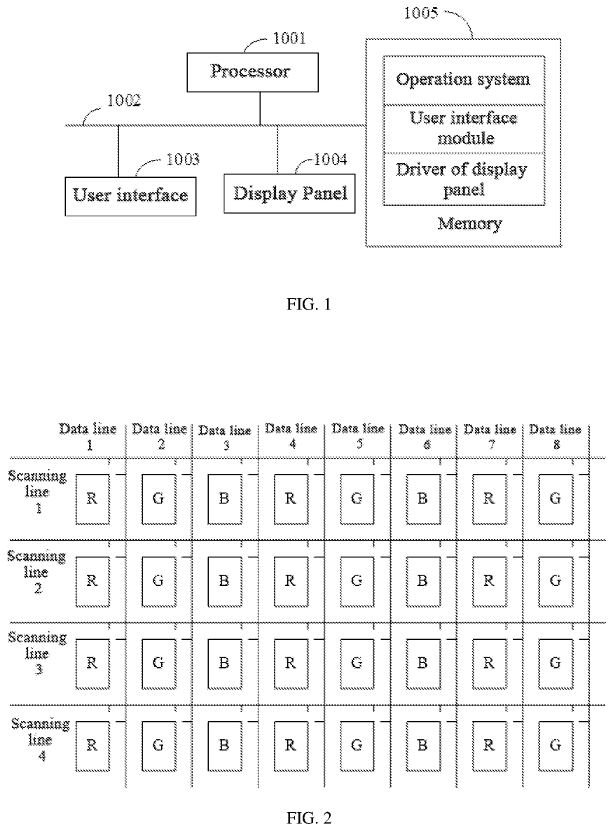

FIG. 1 is a schematic diagram of a structure of a display device of a hardware operating environment of the embodiments of the present disclosure.

As shown in FIG. 1, the display device may include a processor 1001 such as a central processing unit (CPU), a communication bus 1002, a user interface 1003, a display panel 1004, and a memory 1005. The communication bus 1002 is used to implement connection and communication between those components. The user interface 1003 may include a display screen, an input unit such as a keyboard, and an optional user interface 1003 may also include a standard wired interface, and a wireless interface. The network interface 1004 may optionally include a standard wired interface, and a wireless interface (such as a WI-FI interface). The memory 1005 may be a high speed RAM (Random Access Memory), or a non-volatile memory, such as a disk storage. The memory 1005 may further optionally be a storage device independent of the processor 1001. The display panel may be a liquid crystal display panel, or may be another display panel that may realize the same or similar functions.

It will be understood by those skilled in the art that, the structure shown in FIG. 1 does not constitute a limitation of the display device, which may include more or fewer components than shown, or a combination of certain components, or different component arrangements.

As shown in FIG. 1, the memory 1005, as a storage medium, may include an operating system, a network communication module, a user interface module, and a driver of display panel.

In the display device shown in FIG. 1, the network interface 1004 is mainly used for connecting a network and performing data communication with the Internet. The user interface 1003 is mainly used for connecting a user terminal and carrying out data communication with the user terminal. The display device of the present disclosure calls the driver of display panel stored in the memory 1005 through the processor 1001 and executes the driving method of display panel.

Based on the above hardware structure, an embodiment of a driving method of display panel of the present disclosure is proposed.

Referring to FIG. 2, which shows a schematic structural diagram of an exemplary array, a pixel cell array of a display panel is composed of pixel cells defined by crossing a plurality of scanning lines and a plurality of data lines. The pixel cells here are usually sub-pixels of three primary colors used for color display, such as red sub-pixels (Red, R), green sub-pixels (Green, G) and blue sub-pixels (Blue, B) shown in FIG. 2, and each sub-pixel is correspondingly connected with a scanning line and a data line.

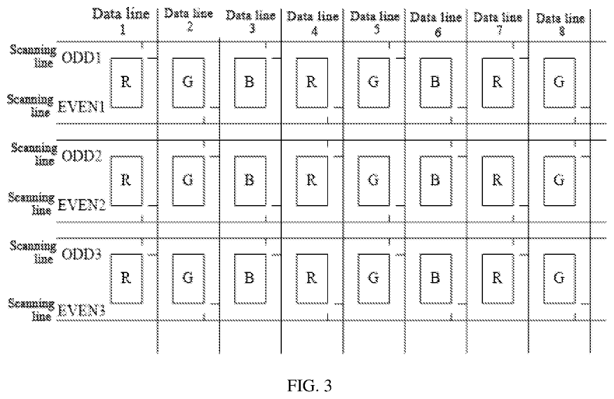

FIG. 3 is a schematic structural diagram of a first embodiment of a display array of the present disclosure. The display panel of FIG. 3 adopts a “2T1C” circuit architecture and may include circuit forms of other architectures, which is not limited in this embodiment. The “2T1C” structure is taken as an example for illustration in this embodiment.

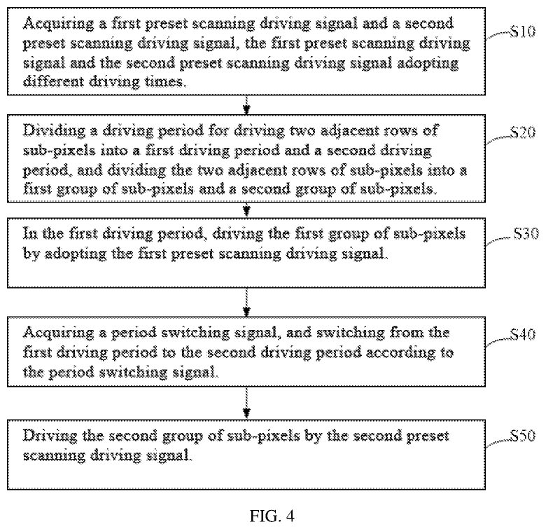

FIG. 4 is a flow diagram of a first embodiment of the driving method of display panel of the present disclosure.

In the first embodiment, the driving method of display panel includes the following operations:

Operation S10, acquiring a first preset scanning driving signal and a second preset scanning driving signal, the first preset scanning driving signal and the second preset scanning driving signal adopting different driving times.

It should be noted that, the first preset scanning driving signal may be a scanning driving signal output from scanning lines ODD1, ODD2 . . . in FIG. 3, the second preset scanning driving signal may be a scanning driving signal output from the scanning lines EVEN1, EVEN2 . . . in FIG. 3. Without changing the original process, the display panel are divided into two groups, such as an ODD group and an EVEN group. Each time one of the two groups is driven to light, thereby to reduce a number of light-emitting components currently emitting light. In this embodiment, the light-emitting components may be light-emitting diodes, such as organic light-emitting diodes (OLEDs), or other light-emitting components which is not limited herein. In this embodiment, OLEDs are taken as examples for explanation.

Operation S20, dividing a driving period for driving two adjacent rows of sub-pixels into a first driving period and a second driving period, and dividing the two adjacent rows of sub-pixels into a first group of sub-pixels and a second group of sub-pixels.

In this embodiment, taking scanning two adjacent rows of sub-pixels as an example, in a specific display panel, there are a plurality of two adjacent rows of sub-pixels. A pixel matrix is formed through orderly arrangement of sub-pixels to achieve the purpose of luminous. The driving period represents the time required to complete scanning of all sub-pixels. Since the embodiment divides the sub-pixels into two group for scanning, in a driving period, only one part of the sub-pixels need to be scanned for driving, and in another driving period, the other part of the sub-pixels need to be scanned for driving, so as to achieve the purpose of alternate driving, reduce the driving frequency of the sub-pixels, and prolong the service life of the OLEDs in the sub-pixels.

Operation 530, in the first driving period, driving the first group of sub-pixels by adopting the first preset scanning driving signal.

In this embodiment, taking the sub-pixels of the adjacent first row and second row in FIG. 3 as an example, odd-numbered column sub-pixels in the first row and even-numbered column sub-pixels in the adjacent second row are driven by the scanning driving signals output by the scanning lines ODD1 and ODD2. Even-numbered column sub-pixels in the first row and odd-numbered column sub-pixels in the adjacent second row are driven by the scanning driving signals output by the scanning lines EVEN1 and EVEN2, and the numbers of sub-pixels of driving of the two adjacent rows are the same, that is, the numbers of red sub-pixels, green sub-pixels and blue sub-pixels are the same, thus ensuring a same brightness in the two driving periods. It is also possible to drive the odd-numbered column sub-pixels in the first row and the even-numbered column sub-pixels in adjacent second rows with scanning driving signals output by scanning lines EVEN1 and EVEN2, which is not limited.

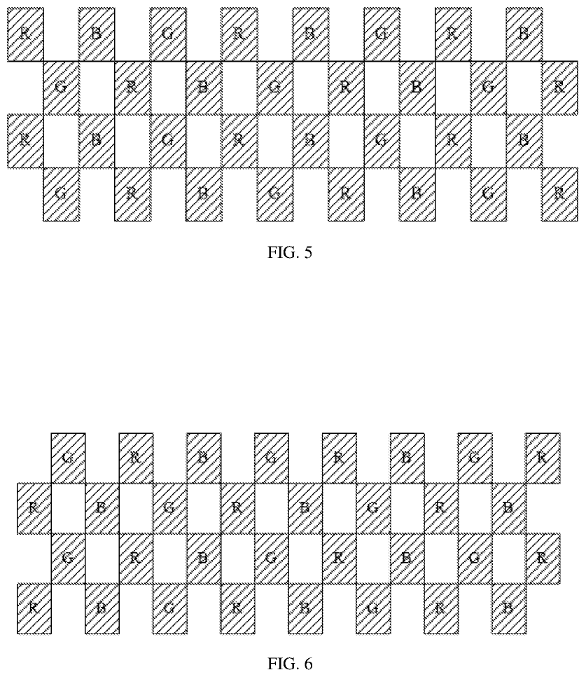

In a specific implementation, the scanning lines in the display array are divided into two groups and set one-to-one correspondingly with corresponding sub-pixels, the scanning lines include a first group of scanning lines and a second group of scanning lines, so as to ensure that each sub-pixel can work normally, as shown in FIG. 5, it shows a schematic diagram of display effect of the first driving period, where a shaded part represents a lighting effect. As can be seen, the first group of scanning lines may be represented by the ODD scanning lines, and the second group of scanning lines may be represented by the EVEN scanning lines, it indicates that only the sub-pixels connected to the first group of ODD scanning lines perform light emission display during the first driving period, and the sub-pixels connected to the second group of EVEN scanning lines do not perform light emission display, thereby reducing the driving frequency of the light emitting diodes.

In operation 540, acquiring a period switching signal, and switching from the first driving period to the second driving period according to the period switching signal.

It should be noted that the period switching signal is a frame signal, a time signal, or an power on/off signal. Since the first preset scanning driving signal and the second preset scanning driving signal adopt different driving times, in order to realize the identification of driving periods, the driving periods may be distinguished by scanning driving signals of different driving times.

In a specific implementation, it can be determined by identifying a frame signal, a time signal and a power on/off signal in the period switching signal to adopt corresponding preset scanning driving signal to drive. For example, in FIG. 3, the first preset driving signal such as ODD1, ODD2 . . . is used for driving, and when the period switching signal is acquired, the second preset driving signal such as EVEN1, EVEN2 . . . is switched for driving.

Operation S50, driving the second group of sub-pixels by the second preset scanning driving signal.

In this embodiment, in FIG. 3, even-numbered column sub-pixels in the first row and odd-numbered column sub-pixels in the adjacent second rows are driven by scanning driving signals output by scanning lines EVEN1 and EVEN2. And sub-pixels being driven of two adjacent rows are the same. Namely, the numbers of red sub-pixels, green sub-pixels and blue sub-pixels are the same, thus ensuring the same brightness in the two driving periods. The odd-numbered column sub-pixels in the first row and the even-numbered column sub-pixels in the adjacent second row can also be driven by the scanning driving signals output by the scanning lines EVEN1 and EVEN2, which is not limited by this embodiment.

In a specific implementation, as shown in FIG. 6, the schematic diagram of display effect of the second driving period is shown. A shaded part represents a lighting effect. It can be seen that only the sub-pixels connected to the second group of EVEN scanning lines perform light emission display in the second driving period, and the sub-pixels connected to the first group of ODD scanning lines do not perform light emission display, thus reducing the driving frequency of the light emitting diode.

In this embodiment, through acquiring a first preset scanning driving signal and a second preset scanning driving signal, the first preset scanning driving signal and the second preset scanning driving signal adopting different driving times; dividing a driving period for driving two adjacent rows of sub-pixels into a first driving period and a second driving period, and dividing the two adjacent rows of sub-pixels into a first group of sub-pixels and a second group of sub-pixels; at the first driving period, driving the first group of sub-pixels by adopting the first preset scanning driving signal; acquiring a period switching signal, switching the first driving period to the second driving period according to the period switching signal; and driving the second group of sub-pixels by adopting the second preset scanning driving signal, it alternately drives the current sub-pixels, reduces the driving frequency of the sub-pixels, and thereby achieving the purpose of improving the service life of the light emitting diodes.

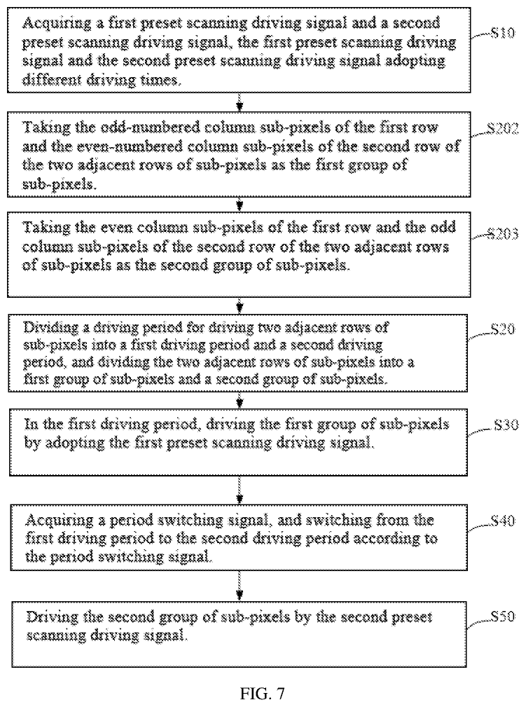

FIG. 7 is a flow diagram of a second embodiment of the driving method of display panel of the present disclosure.

In one embodiment, the operation S20 includes:

dividing the two adjacent rows of sub-pixels into a first group of sub-pixels and a second group of sub-pixels in an odd-even interpolation manner.

It should be noted that, the current sub-pixels can be divided into a plurality of groups and switched alternately. In this embodiment, the current sub-pixels can be set into two groups and can also be set into other numbers of groups. This embodiment is not limited to this. In this embodiment, the current sub-pixels being divided into two groups is taken as an example to illustrate and to reduce the driving frequency of the sub-pixels.

In one embodiment, the operation of dividing the two adjacent rows of sub-pixels into a first group of sub-pixels and a second group of sub-pixels in an odd-even interpolation manner includes:

Operation S202, taking the odd-numbered column sub-pixels of the first row and the even-numbered column sub-pixels of the second row of the two adjacent rows of sub-pixels as the first group of sub-pixels.

In this embodiment, As shown in FIG. 3, the odd-numbered column sub-pixels of the first row and the even-numbered column sub-pixels of the adjacent second row of the current sub-pixels are set as a first group of sub-pixels. The even-numbered column sub-pixels of the first row and the odd-numbered column sub-pixels of the adjacent second row of are set as a second group of sub-pixels. For example, the red sub-pixel, the blue sub-pixel, the green sub-pixel, the red sub-pixel, the blue sub-pixel, and the green sub-pixel in the first row in FIG. 3 are driven by the first scanning driving signal output from the scanning line ODD1, the green sub-pixel, the red sub-pixel, the blue sub-pixel, the green sub-pixel, the red sub-pixel, and the blue sub-pixel in the second row are driven by the first scanning driving signal output by the scanning line ODD2.

Operation S203, taking the even column sub-pixels of the first row and the odd column sub-pixels of the second row of the two adjacent rows of sub-pixels as the second group of sub-pixels.

In this embodiment, the green sub-pixels, the red sub-pixels, the blue sub-pixels, the green sub-pixels, the red sub-pixels and the blue sub-pixels in the first row are also driven by the second scanning driving signal output by the scanning line EVEN1. The red sub-pixel, the blue sub-pixel, the green sub-pixel, the red sub-pixel, the blue sub-pixel and the green sub-pixel in the second row are driven by the second scanning driving signal output by the scanning line EVEN2, thus realizing group driving of the current sub-pixels.

In one embodiment, after operation S50, the method further includes:

obtaining a preset data driving signal, and adopting the same preset data driving signal to drive sub-pixels of a same column of the two adjacent rows of sub-pixels.

It should be noted that, as shown in FIG. 3, in the display panel, the preset data driving signals are data lines 1, data lines 2 and the like, and sub-pixels located in a same column, for example, red sub-pixels in the first column are driven by data lines 1, and green sub-pixels in the second column are driven by data lines 2, so that the original driving mechanism does not need to be changed, and the development cost is reduced.

In one embodiment, prior to operation S10, the method further includes:

arranging sub-pixels of the two adjacent rows as the red sub-pixel, the green sub-pixel and the blue sub-pixel in sequence, thus realizing a color display effect.

In one embodiment, a third embodiment of the driving method of display panel of the present disclosure is proposed. The display panel includes a display array including sub-pixels arranged in an array. The driving method of display panel includes:

dividing scanning lines in the display array into two groups, the scanning lines including a first group of scanning lines and a second group of scanning lines, connecting odd-numbered column sub-pixels of a first row and even-numbered column sub-pixels of a second row of two adjacent rows of sub-pixels with the first group of scanning lines, and connecting even-numbered column sub-pixels of the first row and odd-numbered column sub-pixels of the second row with the second group of scanning lines;

acquiring a first preset scanning driving signal output by the first group of scanning lines and a second preset scanning driving signal output by the second group of scanning lines, the first preset scanning driving signal and the second preset scanning driving signal adopting different driving times;

dividing a driving period for driving the two adjacent rows of sub-pixels into a first driving period and a second driving period;

acquiring a current frame signal, a time signal or a power on/off signal, and driving the odd-numbered column sub-pixels of the first row and the even-numbered column sub-pixels of the second row of the two adjacent rows of sub-pixels by adopting the first preset scanning driving signal during the first driving period;

acquiring a period switching signal, switching from the first driving period to the second driving period according to the period switching signal; and

driving the even-numbered column sub-pixels of the first row and the odd-numbered column sub-pixels of the second row by adopting the second preset scanning driving signal.

The embodiment obtains a first preset scanning driving signal and a second preset scanning driving signal, the first preset scanning driving signal and the second preset scanning driving signal adopting different driving times; divides a driving period for driving two adjacent rows of sub-pixels into a first driving period and a second driving period, and divides the two adjacent rows of sub-pixels into a first group of sub-pixels and a second group of sub-pixels. At the first driving period, the first group of sub-pixels is driven by adopting the first preset scanning driving signal; when a period switching signal is acquired, the first driving period is switched to a second driving period according to the period switching signal; and the second group of sub-pixels is driven by adopting the second preset scanning driving signal, so as to alternately drive the current sub-pixels, reduce the driving frequency of the sub-pixels, and thereby achieving the purpose of improving the service life of the light emitting diodes.

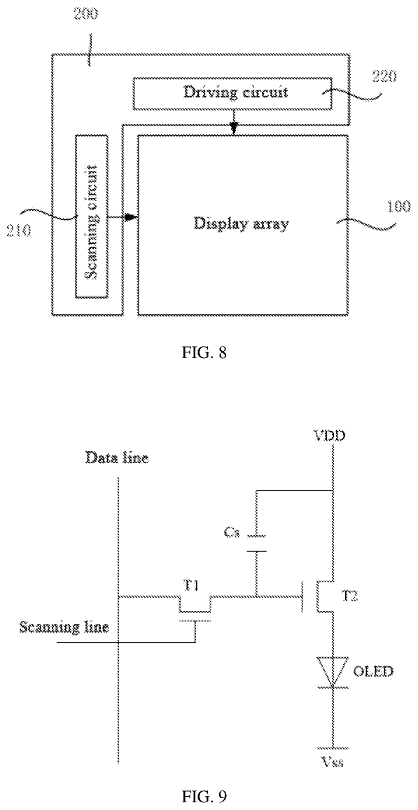

In addition, the embodiments of the present disclosure also provides a display device, As shown in FIG. 8, the display device includes: a display panel 200, a memory, a processor, and a driver of the display panel 200 stored in the memory and executable by the processor. The display panel 200 includes a display array 100. The driver of the display panel 200 is to implement the operations of the embodiments of the driving method of display panel 200 as described above. The display panel 200 further includes a scanning circuit 210 and a driving circuit 220. The scanning circuit 210 is to output a scanning driving signal, to generally scan pixel cells line by line, and the driving circuit 220 is to output a data driving signal, so that the pixel cells receive the driving data for display when being scanned.

The display panel 200 may refer to the above-described embodiments, the display panel 200 acquires a first preset scanning driving signal and a second preset scanning driving signal, the first preset scanning driving signal and the second preset scanning driving signal having different driving times, divides a driving period for driving two adjacent rows of sub-pixels into a first driving period and a second driving period, and divides the two adjacent rows of sub-pixels into a first group of sub-pixels and a second group of sub-pixels. At the first driving period, the first group of sub-pixels is driven by adopting the first preset scanning driving signal. When acquiring a period switching signal, the first driving period is switched to a second driving period according to the period switching signal; and the second preset scanning driving signal is adopted to drive the second group of sub-pixels, so as to alternately drive the current sub-pixels, reduce the driving frequency of the sub-pixels, and thereby achieving the purpose of improving the service life of the light emitting diodes.

In one embodiment, the display panel includes scanning lines, data lines, light emitting diodes, first thin film transistors, second thin film transistors, a first power supply, a second power supply and a storage capacitor. The scanning lines includes a first scanning line to output the first preset scanning driving signal and a second scanning line to output the second preset scanning driving signal.

As shown in FIG. 9, the light emit diode is an OLED, through the organic light emitting diode OLED, many advantages such as self-luminous, ultra-thin, wide viewing angle, low power consumption and flexibility can be realized.

The first thin film transistor is T1, the second thin film transistor is T2. The first power supply is VDD, the second power supply is Vss, the scanning line is connected to a grid of the first thin film transistor, a source of the first thin film transistor is connected to the data line, a drain of the first thin film transistor is connected to a gate of the second thin film transistor. One terminal of the storage capacitor Cs is connected to the drain of the first thin film transistor, the other terminal of the storage capacitor Cs is connected to the source of the second thin film transistor. The source of the second thin film transistor is connected with the first power supply, the drain of the second thin film transistor is connected with a positive electrode of the light emitting diode, and a negative electrode of the light emitting diode is connected with the second power supply, so that the turning on of the light emitting diode is controlled by the thin film transistor with lower cost.

It should be noted that, in this article, the terms “comprising”, “including” or any other variant thereof are intended to encompass non-exclusive inclusion such that a process, method, article, or system that includes a series of elements includes not only those elements, but also other elements that are not explicitly listed, or also elements inherent to such a process, method, article, or system. Without further restrictions, the element defined by the statement “include a . . . ” does not exclude the existence of other identical elements in the process, method, article or system that includes the element.

The above-mentioned serial numbers of embodiments of the present disclosure are for description only and do not represent the advantages and disadvantages of the embodiments.

From the above description of embodiments, it will be apparent to those skilled in the art that the methods of the above embodiments can be implemented by means of software plus the necessary universal hardware platform, of course also by means of hardware, but in many cases the former is a better embodiment. Based on this understanding, the technical scheme of the disclosure can be embodied in the form of software products in essence or part that contributes to the prior art. The computer software product is stored in a storage medium (e.g., a ROM/RAM, a magnetic disk, an optical disk) as described above and includes instructions to cause a terminal device (which may be a mobile phone, a computer, a server, an air conditioner, a network device, etc.) to perform the methods described in various embodiments of the present disclosure.

The above is only an alternative embodiment of the disclosure and is not thereby limiting the scope of the present disclosure. Any equivalent structure or equivalent flow change made by utilizing the contents of the specification and the accompanying drawings of the disclosure, or any directly or indirectly application to other related technical fields, is likewise included in the scope of the present disclosure.

What is claimed is:

1. A driving method of a display panel, wherein, the display panel comprises a display array comprising sub-pixels arranged in an array; the driving method comprises:
acquiring a first preset scanning driving signal and a second preset scanning driving signal, the first preset scanning driving signal and the second preset scanning driving signal being in different driving periods;
dividing a driving period for driving two adjacent rows of sub-pixels into a first driving period and a second driving period, and dividing the two adjacent rows of sub-pixels into a first group of sub-pixels and a second group of sub-pixels;
at the first driving period, driving the first group of sub-pixels by adopting the first preset scanning driving signal;
acquiring a period switching signal, and switching the first driving period to the second driving period according to the period switching signal; and
driving the second group of sub-pixels by adopting the second preset scanning driving signal.

2. The driving method according to claim 1, wherein dividing the two adjacent rows of sub-pixels into a first group of sub-pixels and a second group of sub-pixels comprises:
dividing the two adjacent rows of sub-pixels into the first group of sub-pixels and the second group of sub-pixels in an odd-even interpolation manner.

3. The driving method according to claim 2, wherein, dividing the two adjacent rows of sub-pixels into the first group of sub-pixels and the second group of sub-pixels in an odd-even interpolation manner comprises:
setting odd-numbered column sub-pixels in a first row and even-numbered column sub-pixels in a second row of the two adjacent rows of sub-pixels as the first group of sub-pixels; and
setting even-numbered column sub-pixels in the first row and odd-numbered column sub-pixels in the second row of the two adjacent rows of sub-pixels as the second group of sub-pixels.

4. The driving method according to claim 1, wherein the period switching signal is a frame signal, a time signal, or a power on/off signal.

5. The driving method according to claim 1, wherein after driving the second group of sub-pixels by adopting the second preset scanning driving signal, the method further comprises:
acquiring a preset data driving signal, and driving the two adjacent rows of sub-pixels by adopting the preset data driving signal.

6. The driving method according to claim 1, wherein, before acquiring a first preset scanning driving signal and a second preset scanning driving signal, the method further comprises:
setting the two adjacent rows of sub-pixels as red sub-pixels, green sub-pixels and blue sub-pixels in sequence.

7. A driving method of a display panel, wherein the display panel comprises a display array comprising sub-pixels arranged in an array; the driving method comprises:
dividing scanning lines of the display array into two groups comprising a first group of scanning lines and a second group of scanning lines, connecting odd-numbered column sub-pixels in a first row and even-numbered column sub-pixels in a second row of two adjacent rows of sub-pixels with the first group of scanning lines, and connecting even-numbered column sub-pixels in the first row and odd-numbered column sub-pixels in the second row with the second group of scanning lines;
acquiring a first preset scanning driving signal output by the first group of scanning lines and a second preset scanning driving signal output by the second group of scanning lines, the first preset scanning driving signal and the second preset scanning driving signal adopting different driving times;
dividing a driving period for driving the two adjacent rows of sub-pixels into a first driving period and a second driving period;
acquiring a current frame signal, a time signal or a power on/off signal, and driving the odd-numbered column sub-pixels in the first row and the even-numbered column sub-pixels in the second row of the two adjacent rows of sub-pixels by adopting the first preset scanning driving signal during the first driving period;
acquiring a period switching signal, and switching the first driving period to the second driving period according to the period switching signal; and
driving the even-numbered column sub-pixels in the first row and the odd-numbered column sub-pixels in the second row by adopting the second preset scanning driving signal.

8. A display device comprising a display panel, a memory, a processor, and a driver of the display panel stored in the memory and operable on the processor, the display panel comprising a display array comprising pixel cells arranged in an array, wherein when the driver of the display panel is executed by the processor, the driving method of display panel according to claim 1 is carried out.

9. The display device according to claim 8, wherein the display panel comprises a scanning line, a data line, a light emitting diode, a first thin film transistor, a second thin film transistor, a first power supply, a second power supply and a storage capacitor, the scanning line comprises a first scanning line and a second scanning line, the first scanning line is for outputting a first preset scanning driving signal, and the second scanning line is for outputting a second preset scanning driving signal; and,
the scanning line is connected to a grid of the first thin film transistor, a source of the first thin film transistor is connected to the data line, a drain of the first thin film transistor is connected to a grid of the second thin film transistor, one terminal of the storage capacitor is connected to the drain of the first thin film transistor, the other terminal of the storage capacitor is connected with a source of the second thin film transistor, the source of the second thin film transistor is connected with the first power supply, a drain of the second thin film transistor is connected with a positive electrode of the light emitting diode, and a negative electrode of the light emitting diode is connected with the second power supply.

10. The display device according to claim 9, wherein the light emitting diode is an organic light emitting diode.

11. The display device according to claim 9, wherein dividing the two adjacent rows of sub-pixels into a first group of sub-pixels and a second group of sub-pixels comprises:
dividing the two adjacent rows of sub-pixels into the first group of sub-pixels and the second group of sub-pixels in an odd-even interpolation manner.

12. The display device according to claim 9, wherein the method that dividing the two adjacent rows of sub-pixels into the first group of sub-pixels and the second group of sub-pixels in an odd-even interpolation manner comprises:
setting odd-numbered columns sub-pixels in a first row and even-numbered column sub-pixels in a second row of the two adjacent rows of sub-pixels as the first group of sub-pixels; and
setting even-numbered column sub-pixels in the first row and odd-numbered column sub-pixels in the second row of the two adjacent rows of sub-pixels as the second group of sub-pixels.

13. The display device according to claim 9, wherein the period switching signal is a frame signal, a time signal, or a power on/off signal.

14. The display device according to claim 9, wherein after driving the second group of sub-pixels by adopting the second preset scanning driving signal, the method further comprises:
acquiring a preset data driving signal, and driving the two adjacent rows of sub-pixels by adopting the preset data driving signal.

15. The display device according to claim 9, wherein before acquiring a first preset scanning driving signal and a second preset scanning driving signal, the driver of the display panel is further for realizing the following operations:
setting the two adjacent rows of sub-pixels as red sub-pixels, green sub-pixels and blue sub-pixels in sequence.

16. A display device comprising a display panel, a memory, a processor, and a driver of the display panel stored in the memory and operable on the processor, the display panel comprising a display array comprising pixel cells arranged in an array, wherein when the driver of the display panel is executed by the processor, the driving method of display panel according to claim 7 is carried out.
